(19) United States
(12) Patent Application Publication
(10) Pub. No.: US 2005/0023465 A1
(43) Pub. Date: Feb. 3, 2005

(54) Device for improving visibility in motor vehicles

(76) Inventors: Helmuth Eggers, Ulm (DE); Gerhard Kurz, Wendlingen (DE); Juergen Seekircher, Ostfildern (DE); Thomas Wohlgemuth, Aichtal (DE)

Correspondence Address: PENDORF & CUTLIFF, 5111 Memorial Highway, Tampa, FL, 33634-7356, US

(21) Appl. No.: 10/897,447

(22) Filed: Jul. 23, 2004

(30) Foreign Application Priority Data
Jul. 30, 2003 (DE) 103 35 189.2

(51) Int. Cl. G01J 5/00

(52) U.S. Cl. 250/330

(57) ABSTRACT

The invention concerns a device for improving visibility in a motor vehicle. It includes a radiation source for illumination of the vehicle environment with infrared radiation, an infrared sensitive camera for detection of at least a portion of the illuminated vehicle environment and a display for depicting the image information detected by the camera. In accordance with the invention the camera is provided with a homogenous IR-filter, which exhibits various spectral transmission characteristics. The IR-filter exhibits a degree of transmission of about 1 in at least a partial range of the infrared spectrum. In the visual spectral region, the typical blocking effect of an IR-filter is 10⁻⁵ or less. In the visual spectrum the transmission of the IR-filter according to the invention is not continuous, and includes at least one narrow band transmissive region with a degree of transmissivity of approximately or greater than 10⁻³ for visible light. By this design of the device for improvement of visibility in a motor vehicle, a reliable detection of the environment is made possible, and thus it becomes possible to more reliably visualize the street traffic.

### BACKGROUND OF THE INVENTION

1. Field of Invention

The invention concerns a device for improving visibility in motor vehicles.

An extremely important safety consideration in motor vehicles is to have excellent visibility in all weather conditions. Poor visibility in darkness combined with wet roadways or with fog presents a significantly higher danger of accidents. Modern assist systems are thus designed to support the operator and to protect against accidents. For example, the first automobile night vision systems are already available on the market for this purpose. In the automobile area there are, for example, night vision systems which include active infrared illumination, in order therewith to illuminate the environment ahead of the vehicle with infrared radiation. This type of system detects primarily the environment ahead of the vehicle via infrared sensors. The detected environment information is then processed via a data processing unit into an image and displayed on an image display, where it can be referred to by the driver as required.

2. Related Art of the Invention

One device for improving visibility in a motor vehicle is known from DE 41 07 850 A1. This includes a radiation device for illumination of the environment of the vehicle with infrared radiation, an infrared sensitive camera for detection of at least a portion of the illuminated vehicle environment, and a display for presentation of the image information detected by the camera. In addition, the infrared sensitive camera is provided with an IR-filter, which is transmissive for the infrared radiation of the radiation source, while having a high blocking effect for the rest of the infrared radiation spectrum or, as the case may be, visible radiation. Thereby daylight as well as light from conventional headlights of oncoming vehicles is strongly attenuated and interference with the detected image information by these extraneous light sources is substantially precluded.

The subsequently published patent application with document number DE 10315741 discloses a further device for improving visibility in a motor vehicle. This device includes a radiation source for illuminating the vehicle environment with infrared radiation, an infrared light sensitive camera for detecting at least a portion of the illuminated vehicle environment and a display for presenting the image information detected by the camera. Therein the camera is provided with an IR-filter which has spatially separated areas having differing transmission characteristics. The IR-filter includes at least one spatial area with a degree of transmission of approximately or greater than 10⁻³ for visible light or parts thereof and preferably at least a second spatial area with a degree of transmission of approximately 10⁻⁵ for visible light.

In contrast to the above mentioned IR-filter, which exhibits differing transmission characteristics in different spatial areas, homogenous filters are known, which have the same transmission characteristics in all of their spatial areas. One such homogenous IR-filter is available for example from LINOS PHOTONICS under the designation RG 780. It exhibits in the infrared spectral region, that is, at a wavelength of greater than 780 nm, a degree of transmission of approximately 0.98, in comparison to which in the range of visible light it exhibits a typical degree of transmission of approximately 10⁻⁵.

### SUMMARY OF THE INVENTION

The invention is concerned with the task of providing a further device for improving visibility in motor vehicles, which makes it possible, with simple means, to recognize traffic lights, brake lights or turn signals of other traffic participants in a sufficiently reliable manner.

This task is solved in accordance with the invention by a device for improving visibility in a motor vehicle having the characterizing features of Patent claim 1. Advantageous embodiments and further developments of the invention are set forth in the dependent claims.

In accordance with the invention a device is provided for improving visibility in a motor vehicle. For this purpose the device includes a radiation source for illumination of the vehicle environment with infrared radiation. Further, an infrared sensitive camera is provided for detection of at least a portion of the illuminated vehicle environment. Therein, the infrared sensitive camera is associated with a homogenous IR-filter, which exhibits different transmission characteristics in different spectral ranges. By these differing transmission characteristics it is accomplished that, at least within a partial range of the infrared spectral region, a degree of transmission in the magnitude of 1 is provided. In contrast, in the visual spectral region the typical blocking effect of the IR-filter is a given, and exhibits a degree of transmission of 10⁻⁵ or less, in order to prevent the blinding effect by the light from headlights of oncoming motor vehicles. In accordance with the invention, the homogenous IR-filter exhibits, in a partial range of the visual spectral region, a degree of transmission of 10⁻³ or greater. By the targeted or specific selection of at least a partial range with a higher degree of transmission in the visual spectral region, it has achieved that, by means of at least one single IR-filter, a very simple device is realized for a motor vehicle. This device makes it possible on the one hand to sufficiently suppress the blinding effect, and on the other hand, however, to detect essential information from the environment of motor vehicle, in particular light emitting sources in the vehicle environment, and to recognize these. Important environmental information includes, for example, turn signals and brake lights of preceding vehicles, traffic lights, or in certain cases, other non-actively self-illuminated traffic signs. By this design of the homogenous IR-filter it is achieved that necessary information for the safe guidance of the motor vehicle by the user is made available in simple and reliable manner. Thereby it is achieved that the risk of an accident is significantly reduced.

In an advantageous embodiment of the invention the at least one partial range of the visual spectral region with a degree of transmission of 10⁻³ or greater forms a narrow band spectral filter region. Thereby it becomes possible to selectively view, by means of the device for improving visibility, those specific visual spectral regions in which environmental light sources of interest emit light. Therein it has been found particularly useful that the maximum of this type of spectral filter region is, for example, at a wavelength of 546 nm (green light) or 700 nm (red light). Brakes lights of preceding vehicles and traffic lights, above all, emit light in this spectral region. At the same time traffic signs that are not actively self lit, for example, warning signs, reflect light in the red visual spectral region. In combination with the homogenous IR-filter there is herein basically the possibility to locate the peak transmission of a spectral filter range in any position within the visual or infrared spectral region. For example, it could even be useful to have a spectral filter region with a maximum transmission in the blue or orange spectral range. For example, some emergency vehicles may emit a blue light, other traffic participants may use turn signals for directional indication, or blinking lights may emit light in a certain spectral region at construction sites.

The degree of transmission within this narrow band filter region in the visual spectral region is above the conventional attenuation region of a homogenous IR-filter (for example the IR-filter of Linos Photonics) and is at least 10⁻³. Depending upon the respective spectral region to be viewed, the degree of transmission can at this locus also be substantially higher than 10⁻³ and, for example, reach the maximal value. For example, blue spectral regions can have a higher degree of transmission than red spectral regions, wherein for example red light sources occur more frequently in the vehicle environment than blue. By the individual adaptation of the degree of transmission to various spectral filter regions the quality of the representation in the displayed image information can be improved. In particular it becomes possible to prevent in advantageous manner a blinding effect as caused for example by oncoming vehicles, since in targeted or selective manner only certain regions of the visual spectral range are permitted to have a higher degree of transmission.

These spectral filter regions with a degree of transmission in the visual spectral realm greater than the blocked range form, in a preferred embodiment of the invention, narrow bandpass filters. Therein the half width (width at half maximum intensity) of the spectral filter is to be, for example, only a few nanometer. The spectral filter can be selected to be a narrower band the higher the emitted light energy is in the selected spectral region. The regions adjacent these spectral regions exhibit, in comparison, a blocking with respect to visual radiation, wherein the degree of transmission in the areas having a blocking effect is smaller than the conventional damping of the homogenous IR-filter, for example 10⁻⁵. Thereby it is possible in particularly advantageous manner to attenuate the detected light energy of, for example, headlights of oncoming motor vehicles. For example, conventional xenon headlights are characterized by an even emission spectrum, which extends over the entire spectral region. This type of light source would, since it is not limited to a specific visual spectral region, not result in an attenuation effect in the display of the image data recorded by the means of the device for improving visibility. Herein it is also possible to use a broad bandpass, wherein the level of the attenuation is raised overall.

In a further advantageous embodiment of the invention the homogenous IR-filter provides in at least one partial region of the visual spectral region a narrow band spectral blocking region, in which the transmission, relative to the other spectral regions, is significantly suppressed below a value of 10⁻⁵, preferably below 10⁻⁷. Thereby it is possible to selectively suppress this type of visual spectral region, in which undesired environmental light sources emit visual radiation. For example, xenon lights employed in modern motor vehicle headlights are conventionally characterized by a slight blue coloration of the emitted visual radiation. Thus the spectrum of these xenon lamps exhibits an emission band at approximately 480 nm. This emission band can be suppressed for example with a homogenous IR-filter, which has in the visual spectral region a narrow band blocking range with a maximum at 480 nm and in which no transmission occurs. In general, herein the maximum of a spectral blocking range of this type can be selected as desired, analogously to the above described spectral filter regions which are transparent for visual radiation.

In particularly advantageous manner the IR-filter is an absorption filter. With optical filters in general the transmitted radiation is selected depending upon wavelength and attenuated or only weakened depending upon wavelength. In absorption filters the attenuation of the radiation passing through the filter occurs in general by absorption in the filter material. The absorption characteristic or behavior of different filter materials is described therein as the absorption co-efficient. Absorption filters can therein be in the form of, for example, massive filters, for example as color glass filters, crystal glass filters, semi-conductor filters or plastic filters. Embodiments are also known in the form of thin films or layers, for example gelatin, lacquer or metal filters. Beyond this there are known for example liquid and gas filters in cuvets.

Alternatively to this the IR-filter could be a reflection filter. This does not refer to Fresnel reflection, which occurs for example in the boundary layer during transition between air and the respective filter medium and depends essentially upon the refractive index between the respective filter medium. The term reflection filter herein is intended to mean for example interference filters. The spectral characteristics of interference filters are determined by the interferences with multiple reflections in thin layer systems. For example, interference filters may be built up as metal layer filters, wherein for example a transparent dielectric layer is bordered by two partially permeable (half mirror) metallic mirror layers. It is also possible to have multiple individual interference filters (cavities) arranged sequentially. The layer thickness over the separations between the mirror layers determine the spectral position of the transmission range, and with increasing number of the individual layers in the reflector can increase the band breadth. Interference filters thereby produce the so-called secondary maximum which can be filtered out using, for example, colored glass.

There is also the possibility that the IR-filter is a polarization filter. The filter characteristics of polarization filters are based upon the wavelength selectivity of the degree of polarization. In general, light can be polarized linear, circular or elliptical. Polarization filters allow light to be transmitted in only a particular polarization direction. For example, polarization filters are know for linear polarized light, which transmit linear polarized light for example either in a horizontal or a vertical direction. There is also the possibility in association with the present invention that the IR-filter is a scatter filter. The filter characteristics of scatter filters are based upon a wavelength dependence of the scatter characteristic.

In an advantageous embodiment of the invention the IR-filter is integrated in an infrared sensitive camera. The infrared sensitive camera is preferably a CCD- or CMOS-camera. The preferred CMOS-cameras have a non-linear logarithmic sensitivity curve, which substantially simplifies the image evaluation of the image data subsequent to a camera with extreme dynamic variation. The CCD-cameras exhibit very compact, robust and economical construction. In advantageous manner the IR-filter is integrated as a separate construction component independent of other components in the housing of the infrared light sensitive camera. In advantageous manner the IR-filter remains protected thereby from environmental influences.

In a further advantageous embodiment of the invention the IR-filter is integrated in the lens of the camera. The employed homogenous IR-filter is therein preferably a glass filter, which exhibits a desired filter characteristic due to its glass composition or as the case may be as a result of its coating, in particular its wavelength dependent transmission characteristics. There is also the possibility of using other filter materials for the composition of the IR-filter, such as polymers. The IR-filter is preferably connected to the lens of the infrared light sensitive camera directly as a round filter, wherein it is seated, screwed or bayonet attached directly to the camera lens. There is also the possibility that the IR-filter is applied in the form of a layer directly to the outer surface of the lens. Therein it is also possible to provide the layer as an intermediate layer of the lens. Beyond this, other designs of an IR-filter are possible, which are so associated with the infrared sensitive camera, that they are located in the optical path of the environment detected by the infrared sensitive camera. By the use of the IR-filter in combination with the camera lens a very simple, robust configuration of a device for improving the view in a motor vehicle is provided.

There is also the possibility, that the IR-filter is integrated directly in the chip of the camera. The camera chip is therein essentially a light-sensitive photo element, which can be provided in the manner of a camera cell or as an array. Therein it is envisioned, with a particularly advantageous embodiment of the inventive device, that the IR-filter is a light transmissive layer applied directly upon the substrate of the photo element. Thereby the IR-filter is, on the one hand, protected from environmental influences and, on the other hand, no further construction components are required such as mountings or separate carriers.

Alternatively to this in one embodiment of the invention it is envisioned that the IR-filter is provided as a separate construction component outside of the camera. For this, various installation cites on the motor vehicle are conceivable for mounting the IR-filter in the optical beam path between the camera chip and the environment to be observed. For example, the installation or mounting of IR-filters can be in combination with the headlight lenses or vehicle windows. Alternatively to this there is for example also the possibility to provide openings in the area of the radiator grill or other body parts as well as in the body itself for the IR-filter.

In a preferred embodiment of the invention the IR-filter is a combination of multiple filters. For example, various materials exist which are suitable for use as optical filter materials. Each of these filter materials exhibit an individual wavelength-dependent transmission spectrum. For producing a specific transmission characteristic, which is particularly suited in particular in connection with the invention for improving visibility in the framework of environment recognition in motor vehicles, it can be advantageous when multiple filters are combined into an IR-filter unit. For this, filters can be combined in advantageous manner, for example on the basis of their spectral characteristics, wherein for example distinctions can be made between edge filters, spectral filters (broadband, narrow band and band pass filters) as well as neutral gray filters. Further, a combination of different filters is possible on the basis of their physical working principles; distinctions can be made as already described above, for example, between absorption, reflection, polarization and scattered light filters. The person of ordinary skill in the art of optics is, beyond this, familiar with other embodiments for optical IR-filters. In the case of the combination of multiple filters into an IR-filter it is not essential that the individual filters are in direct spatial contact with each other. Therein it can be particularly of advantage, that the individual filters are provided separated from each other at different locations. In association with automotive vehicles there is the possibility that, when the camera is in the headlight, a filter is separately provided in the headlight lens, camera lens and/or on the camera chip.

The invention is not limited to the above explicitly described embodiments of the invention, but rather simple modifications of the described embodiments of the inventive device for improving the visibility in a motor vehicle are within the scope of the invention.

### BRIEF DESCRIPTION OF THE DRAWINGS

In the following the invention will be described on the basis of an exemplary embodiment of a device for improving the visibility in a motor vehicle or, as the case may be, an IR-filter for such a vehicle. There is shown:

FIG. 1 a schematic design of an inventive exemplary device for improving the visibility in a motor vehicle, and

FIG. 2 an example of the spectral characteristics of the inventive device for improving the visibility in a motor vehicle.

### DETAILED DESCRIPTION OF THE INVENTION

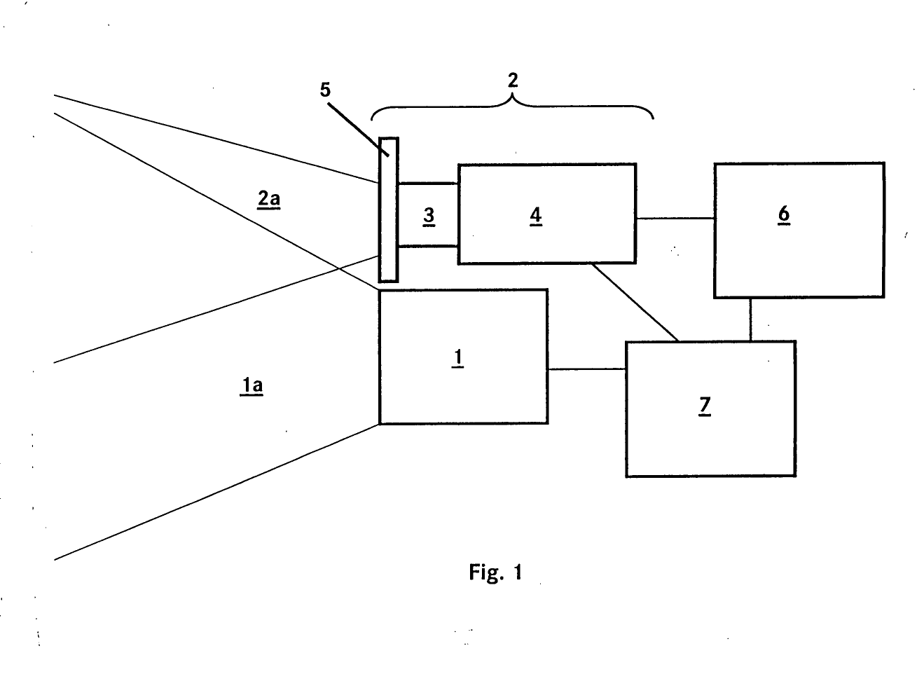

FIG. 1 shows a schematic representation of the interrelation or, as the case may be, the design of an inventive device for improving the view in a motor vehicle.

An infrared light source 1, which here is an infrared LED-headlight, is used to illuminate the environment of the vehicle with infrared radiation. The area 1a illuminated with infrared radiation is at least partially detected by the infrared sensitive camera 2. The detection range of the infrared sensitive camera 2a here is not coextensive with the illumination range la of the infrared radiation source 1. The elements of the environment illuminated by the radiation source 1, which are in the detection area 2a of the camera 2, as well as elements which are not in the illuminated range but are however in the detection range of the camera 2a, are detected by the infrared sensitive camera 1. This detection occurs with the aid of the lens 3 and the image processing unit 4 in the camera 2.

Beyond this the lens 3 is provided with a homogenous IR-filter 5, wherein the homogenous IR-filter 5 exhibits a degree of transmission of 10⁻³ or greater in at least a partial area of the visual spectral range. In addition to this the homogenous IR-filter 5 forms a narrow band pass filter region in at least a partial range of the visual spectrum, in which no transmission occurs. In comparison to this, in at least a partial range of the infrared spectral region, at wavelengths above 780 nm, a degree of transmission of about 1 is exhibited. Accordingly the lens 3 and the image processing unit 4 of the camera 2 are not supplied only with image signals which are transmitted via infrared radiation, but rather, beyond this, also image signals of significant strength, which are transmitted via visible radiation. By the feed or supply of these two types of image information it is ensured that both the elements irradiated with IR-radiation, that means, on the one hand the elements of the environment which have been irradiated by the IR-radiation source 1 as well as those passively radiating, for example, thermal radiation emitting elements, are reliably detected on the basis of their IR-radiation and can be represented, as well as also elements which emit visible radiation of sufficient intensity. A complete suppression of the visible radiation, as is the case in the state of the art, is not realized in accordance with the present invention.

Thereby it is possible for example to detect preceding motor vehicles by their brake lights or turn signals or to detect the green light from traffic lights or also a blue light from emergency vehicles reliably by the camera 2 with the homogenous IR-filter 5, the lens 3 and the image processing unit 4 and to reliably represent image information in the display 6 associated with the camera which image information is transmitted and detected on the basis of visual radiation as well as image information transmitted and detected on the basis of the infrared radiation, and to make this information available for use by the vehicle operator. The display unit 6 is typically a flat screen TFT- or LCD-display or even a heads up display. It is however not essential in association with the present invention that the image information is presented on a display 6. In advantageous manner the detected image information can be further processed using a here not shown additional computer unit, for example an object recognition can be carried out. Beyond this, functionalities are possible via the image processor, such as adaptation of the dynamic scope, selection of certain image information, highlighting particular image information, classification of the detected image information or also only color or light intensity correction by the image processor.

The radiation source 1, the camera 2 and the display 6 are connected with a control unit 7 of the device for improving the view in a motor vehicle, which selectively switches on or off or, as the case may be, controls the individual components of the device. Therein the control is so carried out, that an endangerment of the environment, for example by illumination from the infrared radiation source, is substantially precluded.

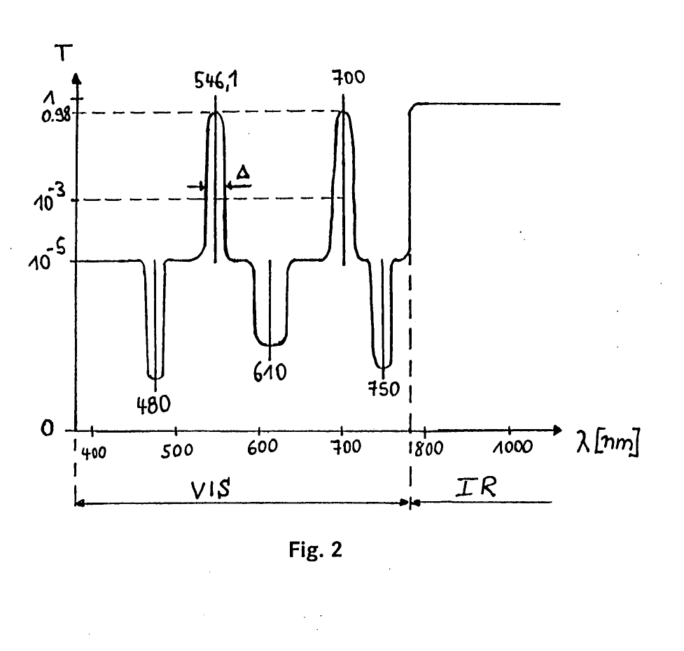

FIG. 2 shows an example of the spectral characteristics of the inventive device for improving the view in a motor vehicle.

Therein in particular the spectral degree of transmission of the homogenous IR-filter is shown. The spectral range shown in FIG. 2 is divided into a visual spectral region (VIS=380 nm-780 nm) in which visible radiation occurs and an infrared spectral region in which non-visible infrared radiation (IR>780 nm) occurs. In the infrared spectral region the homogenous IR-filter exhibits a continuous degree of transmission of 0.99. In the visual spectral region in comparison the homogenous IR-filter exhibits two regions of transmissivity with a degree of transmission of greater than 10⁻³ for visible radiation. One of these transmission regions transmits green light (546.1 nm) and the other transparent region transmits red light (700 nm), whereby it is ensured that important information can be recognized, for example information from traffic lights. As an example herein there is shown the half value A of both transmissive regions which here have a value of approximately 25 nm. In addition there are in the visual spectral region three blocking regions with a degree of transmission of less than 10⁻⁵, wherein the typical attenuation in the visual spectral region is 10⁻⁵. A maximum of these blocking regions is for example at a wavelength of 480 nm. This corresponds to the wavelengths at which for example xenon headlights generally have an emission characteristic spectrum or band, which is apparent from the fact that xenon lamps emit a bluish light. This homogenous IR-filter thus attenuates the blue component of xenon lamps, which has been found to be particularly irritating in the case of oncoming vehicles, particularly during rain. With the inventive device for improving visibility in motor vehicles and by means of the homogenous IR-filter it is accomplished on the one hand that a blinding effect in the visual spectrum, which is caused for example by oncoming vehicles, is avoided. On the other hand it is made possible that important information for the safe guidance of the motor vehicle is made available in a simple and reliable manner.

1. A Device for improving visibility in motor vehicles, including a radiation source for illumination of the vehicle environment with infrared radiation, an infrared sensitive camera for detection of at least a portion of the illuminated vehicle environment, and a homogenous IR-filter associated with the camera, that wherein the homogenous IR-filter exhibits, in at least a part of the range of the visual spectral region, a degree of transmission of 10⁻³ or greater.

2. A Device for improving visibility in motor vehicles according to claim 1, wherein the at least one partial range of the visual spectral region with a degree of transmission of 10⁻³ or greater forms a narrow band spectral filter region.

3. A Device for improving visibility in motor vehicles according to claim 1, wherein the homogenous IR-filter forms a narrow band spectral blocking region in at least a partial region of the visual spectral range, in which the transmission is significantly suppressed in relation to the other spectral regions.

4. A Device for improving visibility in motor vehicles according to claim 1, wherein the IR-filter is an absorption filter.

5. A Device for improving visibility in motor vehicles according to claim 1, wherein the IR-filter is a reflection filter.

6. A Device for improving visibility in motor vehicles according to claim 1, wherein the IR-filter is a polarization filter.

7. A Device for improving visibility in motor vehicles according to claim 1, wherein the IR-filter is a scatter filter.

8. A Device for improving visibility in motor vehicles according to claim 1, wherein the IR-filter is integrated into the infrared sensitive camera.

9. A Device for improving visibility in motor vehicles according to claim 8, wherein the IR-filter is integrated into the lens of the camera.

10. A Device for improving visibility in motor vehicles according to claim 8, wherein the IR-filter is integrated directly into the chip of the camera.

11. A Device for improving visibility in motor vehicles according to claim 1, wherein the IR-filter is a separate construction component outside of the camera.

12. A Device for improving visibility in motor vehicles according to claim 1, wherein the IR-filter is a combination of multiple filters.
